(19) United States
(12) Patent Application Publication
(10) Pub. No.: US 2014/0168714 A1
(43) Pub. Date: Jun. 19, 2014

(54) IMAGE PROCESSING TERMINAL, IMAGE PROCESSING SYSTEM, AND COMPUTER-READABLE STORAGE MEDIUM STORING CONTROL PROGRAM OF IMAGE PROCESSING TERMINAL

(71) Applicant: MONICA MINOLTA, INC., Tokyo (JP)

(72) Inventors: Kazumi SAWAYANAGI, Itami-shi (JP); Kazuaki TOMONO, Okazaki-shi (JP); Kenichi TAKAHASHI, Sennan-gun (JP); Kenji MATSUHARA, Kawanishi-shi (JP); Yosuke TANIGUCHI, Osaka-shi (JP)

(73) Assignee: KONICA MINOLTA, INC., Tokyo (JP)

(21) Appl. No.: 14/104,941

(22) Filed: Dec. 12, 2013

(30) Foreign Application Priority Data
Dec. 19, 2012 (JP) 2012-277324

(51) Int. Cl. H04N 1/00

(52) U.S. Cl. CPC H04N 1/00461
USPC 358/3.28; 358/452

(57) ABSTRACT

An image processing terminal includes a photographing section to photograph an image of a subject. A display section displays the image. An electronic additional information obtaining section obtains electronic additional information. A display control section displays the image with an air tag superimposed over the image. The air tag includes an image object corresponding to the electronic additional information. An image analysis section analyzes the image. In the case where, while the display section is displaying a plurality of air tags, the photographing section photographs a user of the image processing terminal pointing to a particular position within the subject at a fingertip, the image analysis section specifies a position of the fingertip so as to specify the particular position, and the display section displays an air tag corresponding to the particular position.

### CROSS-REFERENCE TO RELATED APPLICATIONS

The present application claims priority under 35 U.S.C. §119 to Japanese Patent Application No. 2012-277324, filed Dec. 19, 2012. The contents of this application are incorporated herein by reference in their entirety.

### BACKGROUND OF THE INVENTION

1. Field of the Invention

The present invention relates to an image processing terminal, an image processing system, and a computer-readable storage medium storing a control program of an image processing terminal.

2. Discussion of the Background

In recent years, in the field of smartphones, tablet terminals, and other image processing terminals capable of image processing, active research and study have been under way regarding the technology of obtaining various kinds of information from a database on a server and displaying the obtained information on a terminal in an attempt to minimize the amount of retention data at the terminal side. For example, Japanese Unexamined Patent Application Publication No. 2007-264992 discloses use of this technology to facilitate document search.

Another example is recited in Japanese Unexamined Patent Application Publication No. 2009-230748, which discloses placing a two-dimensional bar code stamp on a printed material, such as a paper medium, and scanning the stamp under an image processing terminal, for the purpose of using the stamp in document authentication.

For further example, Japanese Unexamined Patent Application Publication No. 2009-301350 discloses a technique associated with an imaginary image display system. In the imaginary image display system, a photographing section photographs a real image, and in response, an image object is read from an image object storage. The image object is superimposed over the real image, resulting in an imaginary image. By displaying the resulting imaginary image, an expanded sense of reality is generated.

Many image processing terminals such as smartphones and tablet terminals are provided with a camera capability such as a CMOS image sensor. The camera capability is used to photograph a particular subject on a paper medium or other printed material. In accordance with the photographed real image of the subject, an image object (which is herein referred to as air tag) is superimposed over the real image, resulting in an imaginary image. The resulting imaginary image is displayed on the display of an image processing terminal. In this manner, it is possible to generate an expanded sense of reality.

A possible air-tag application is that while a printed material such as an operation manual of any of various appliances are photographed by an image processing terminal, the display of the image processing terminal displays a real-time image of the printed material and an air tag superimposed over the real-time image. In this case, air tags may be superimposed over a particular position (for example, a particular word and a particular drawing) on the printed material displayed in real time on the display. The air tags indicate item names of electronic information to be added (which will be hereinafter referred to as electronic additional information, examples including help information explaining the word, a detailed configuration of the drawing, and moving image information on appliance operation statuses).

Specifically, using image analysis technology, the image processing terminal analyzes a two-dimensional code or a similar identifier printed in advance on a printed material, thus specifying the printed material. When electronic additional information exists that is related in advance to the printed material, the electronic additional information is read and the display displays air tags in the vicinity of a particular position on the printed material specified in the electronic additional information. A possible manner of displaying the air tags to display item names indicating the content of the electronic additional information is by the use of text in what is called a balloon often used in cartoons. Then, a user can touch any of the air tags displayed on the display, where it has a touch screen capability, to have the electronic additional information displayed on the display.

Here, it is possible to store the electronic additional information not in the image processing terminal but in a database on a server that is connectable to the image processing terminal through a network. In this case, where necessary, the user can handle the image processing terminal to call up the electronic additional information. Thus, it is possible to store the electronic additional information in, instead of the image processing terminal, a database on a server connectable to the image processing terminal through a network. This ensures a reduced memory capacity of the image processing terminal, and additionally, ensures collective update of the electronic additional information at the server side.

Unfortunately, with an image processing terminal capable of displaying air tags, displaying a large number of air tags on the touch screen display can cause an erroneous touch on an adjacent air tag on the touch screen display. Thus, it can be difficult to select a desired air tag. This problem applies particularly in smartphones and similar image processing terminals that have a limited display area.

The present invention has been made in view of the above-described circumstances, and it is an object of the present invention to provide an image processing terminal, an image processing system, and a control program of an image processing terminal that ensure selection of a desired air tag even when a large number of air tags exist.

### SUMMARY OF THE INVENTION

According to one aspect of the present invention, an image processing terminal includes a photographing section, an electronic additional information obtaining section, a display control section, and an image analysis section. The photographing section is configured to photograph an image of a subject. The display section is configured to display the image of the subject photographed by the photographing section. The electronic additional information obtaining section is configured to obtain electronic additional information to be added to the image of the subject photographed by the photographing section. The display control section is configured to control the display section to display the image of the subject with at least one air tag superimposed over the image of the subject. The at least one air tag corresponds to the electronic additional information obtained by the electronic additional information obtaining section. The image analysis section is configured to analyze the image of the subject photographed by the photographing section. The at least one air tag includes a plurality of air tags. In the case where, while the display section is displaying the plurality of air tags, the photographing section photographs an operation of pointing to a particular position within the subject by a fingertip of a user of the image processing terminal, the image analysis section is configured to specify a position of the fingertip in the subject photographed by the photographing section so as to specify the particular position within the subject pointed to by the fingertip, and the display section is configured to display an air tag, among the plurality of air tags, corresponding to the particular position specified by the image analysis section.

According to another aspect of the present invention, an image processing terminal includes a photographing section, an electronic additional information obtaining section, a display control section, and an image analysis section. The photographing section is configured to photograph an image of a subject. The display section is configured to display the image of the subject photographed by the photographing section. The electronic additional information obtaining section is configured to obtain electronic additional information to be added to the subject photographed by the photographing section. The display control section is configured to control the display section to display the image of the subject with at least one air tag superimposed over the image of the subject. The at least one air tag corresponds to the electronic additional information obtained by the electronic additional information obtaining section. The image analysis section is configured to analyze the image of the subject photographed by the photographing section. The at least one air tag includes a plurality of air tags. In the case where, while the display section is displaying the plurality of air tags, the photographing section executes zoom-in or closeup with respect to a particular position within the subject, the image analysis section is configured to specify the particular position within the subject that has been subjected to the zoom-in or the closeup by the photographing section, and the display section is configured to display an air tag, among the plurality of air tags, corresponding to the particular position specified by the image analysis section.

According to another aspect of the present invention, an image processing system includes any of the above-described image processing terminals, and a server connectable to the image processing terminal through a network. The server includes a database that stores electronic additional information of a subject in relation to a particular code to specify the subject. The image processing terminal is configured to transmit to the server a particular code to specify the subject photographed by a photographing section of the image processing terminal, and is configured to receive from the server the electronic additional information of the subject so that an electronic additional information obtaining section of the image processing terminal obtains the electronic additional information.

According to another aspect of the present invention, a computer-readable storage medium stores a control program of an image processing terminal subject. The image processing terminal includes a photographing section and a display section. The photographing section is configured to photograph an image of a subject. The display section is configured to display the image of the subject photographed by the photographing section. The control program causes a computer to perform obtaining electronic additional information to be added to the subject photographed by the photographing section. The display section is controlled to display the image of the subject with at least one air tag superimposed over the image of the subject. The at least one air tag corresponds to the electronic additional information obtained in the obtaining step. In the case where, while the display section is displaying a plurality of air tags in the controlling step, the photographing section photographs an operation of pointing to a particular position within the subject by a fingertip of a user of the image processing terminal, a position of the fingertip in the subject photographed by the photographing section is specified so as to specify the particular position within the subject pointed to by the fingertip. The display section is controlled to display an air tag, among the plurality of air tags, corresponding to the particular position specified in the image analysis performing step.

According to the other aspect of the present invention, a computer-readable storage medium stores a control program of an image processing terminal subject. The image processing terminal includes a photographing section and a display section. The image processing terminal is configured to photograph an image of a subject. The display section is configured to display the image of the subject photographed by the photographing section. The control program causes a computer to perform obtaining electronic additional information to be added to the subject photographed by the photographing section. The display section is controlled to display the image of the subject with at least one air tag superimposed over the image of the subject. The at least one air tag corresponds to the electronic additional information obtained in the obtaining step. In the case where, while the display section is displaying a plurality of air tags in the controlling step, the photographing section executes zoom-in or closeup with respect to a particular position within the subject, the particular position within the subject that has been subjected to the zoom-in or the closeup by the photographing section is specified. The display section is controlled to display an air tag, among the plurality of air tags, corresponding to the particular position specified in the specifying step.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an exemplary configuration of an image processing system according to embodiment 1.

FIG. 2 is a block diagram illustrating a detailed configuration of an image processing terminal 100;

FIG. 3 illustrates a relationship between a subject MN and electronic additional information;

FIG. 4 illustrates exemplary air tags displayed on the image processing terminal 100;

FIG. 5 is a flowchart of processing executed at the image processing terminal 100 and a server 300;

FIGS. 6A and 6B illustrate states in which air tags are superimposed over the subject MN displayed in real time on the display section 101;

FIG. 7 is a state transition diagram illustrating how the electronic additional information is displayed when a particular air tag is pointed to from among a plurality of air tags; and

FIG. 8 is a flowchart of processing executed at the image processing terminal 100 and the server 300 in an image processing system according to embodiment 2.

### DESCRIPTION OF THE EMBODIMENTS

### Embodiment 1

This embodiment is regarding an image processing system and a method for processing an image. In the image processing system and the method, a user of the image processing terminal performs an operation of pointing to a particular position within the subject at a fingertip of the user on the subject instead of on the display section. Based on this operation, an image processing section specifies the position of the fingertip on the display section, thereby specifying the particular position within the subject. Among a plurality of air tags, only an air tag that is corresponding to the particular position is displayed on the display section.

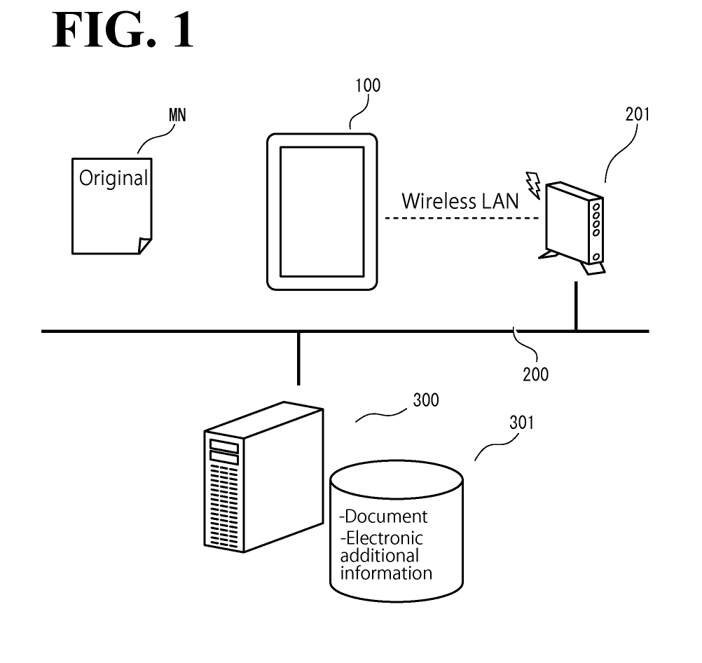

FIG. 1 illustrates an exemplary configuration of an image processing system according to this embodiment. This image processing system includes an image processing terminal 100, a network 200, and a server 300. The image processing terminal 100 is a portable information device capable of image processing, examples including a smartphone and a tablet terminal. The network 200 is a communication network that may be either a closed network such as LAN (Local Area Network) or an open network such as the Internet. The server 300 is dedicated to the image processing terminal 100 as server 300's client.

The image processing terminal 100 is connectable to the network 200 through a wireless LAN access point 201. The image processing terminal 100 is also connectable to the server 300 through the network 200. The server 300 includes a database 301.

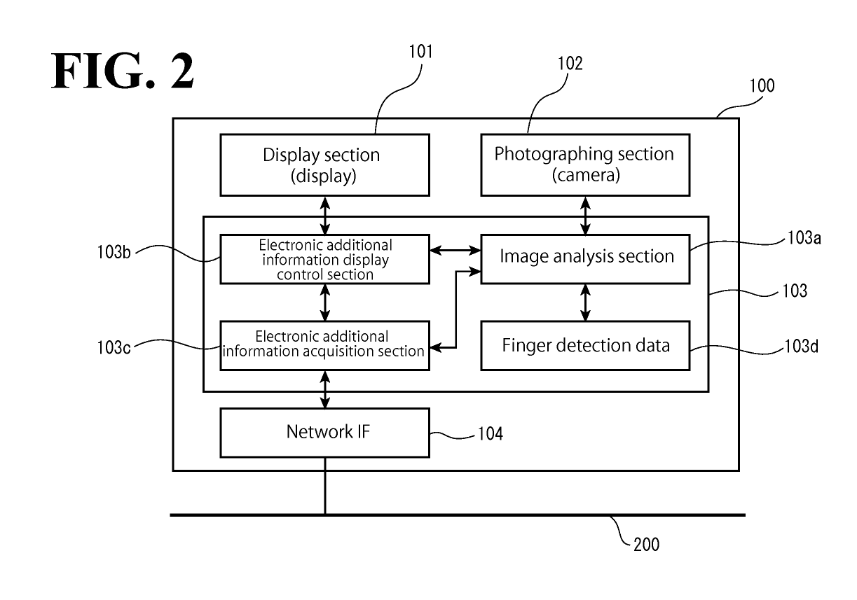

FIG. 2 is a block diagram illustrating a detailed configuration of the image processing terminal 100. The image processing terminal 100 includes a liquid crystal display, an organic EL (ElectroLuminescence) display, or any other display, and includes a display section 101, a photographing section 102, an image processing section 103, and a network interface 104. The display section 101 has a touch screen capability. The photographing section 102 includes a CMOS (Complementary Metal Oxide Semiconductor) image sensor camera, a CCD (Charge Coupled Device) image sensor camera, or any other camera. The image processing section 103 performs image processing with respect to an image to be displayed on the display section 101 and with respect to an image photographed by the photographing section 102. The network interface 104 is an interface for connection with the network 200. For simplicity of description of FIG. 2, the wireless LAN access point 201 is not shown between the image processing terminal 100 and the network 200.

The image processing terminal 100 according to this embodiment is capable of, using the photographing section 102, photographing a subject MN, which is a paper medium or other printed material indicated as “original” in FIG. 1. The image processing terminal 100 is also capable of, using the display section 101, displaying in real time the subject MN photographed by the photographing section 102. Then, in accordance with the photographed real image of the subject MN, the image processing section 103 of the image processing terminal 100 superimposes air tags, which are image objects, over the real image, resulting in an imaginary image. The image processing section 103 then displays the resulting imaginary image on the display section 101. In this manner, the image processing section 103 is capable of generating an expanded sense of reality.

Here is a possible example of how to use air tags. In the case where the subject MN is an operation manual or a similar printed material of any of various kinds of appliances, while the photographing section 102 is photographing the subject MN, the display section 101 may display air tags in such a manner that the air tags are superimposed over a real-time image of the subject MN, which is a printed material, or that the air tags are superimposed over electronic data of the subject MN (for example, PDF (Portable Document Format) data or JPEG (Joint Photographic Experts Group) data, which would be obtained by scanning the subject MN in advance). In this case, in accordance with a particular position within the printed material (for example, a particular word and a particular drawing) displayed on the display section 101, the image processing section 103 may show the superimposed air tags as item indicators of electronic additional information that are electronic information corresponding to the particular position and to be added to the subject MN (examples of the electronic additional information including help information explaining the word, a detailed configuration of the drawing, and moving image information on appliance operation statuses).

Here, the electronic additional information is not necessarily stored in the image processing terminal 100. The electronic additional information may also be stored, together with the electronic data of the subject MN, in a database 301 on the server 300, which is connectable to the image processing terminal 100 through the network 200. This ensures that the user, as necessary, can handle the image processing terminal 100 to call up the electronic additional information and the electronic data of the subject MN. Thus, the electronic additional information is not stored at the image processing terminal 100 side but at the database 301 side on the server 300. This ensures a reduced memory capacity of the image processing terminal 100, and additionally, ensures collective update of the electronic additional information at the server 300 side. The following description takes, as an example, storing the electronic additional information in the database 301 on the server 300.

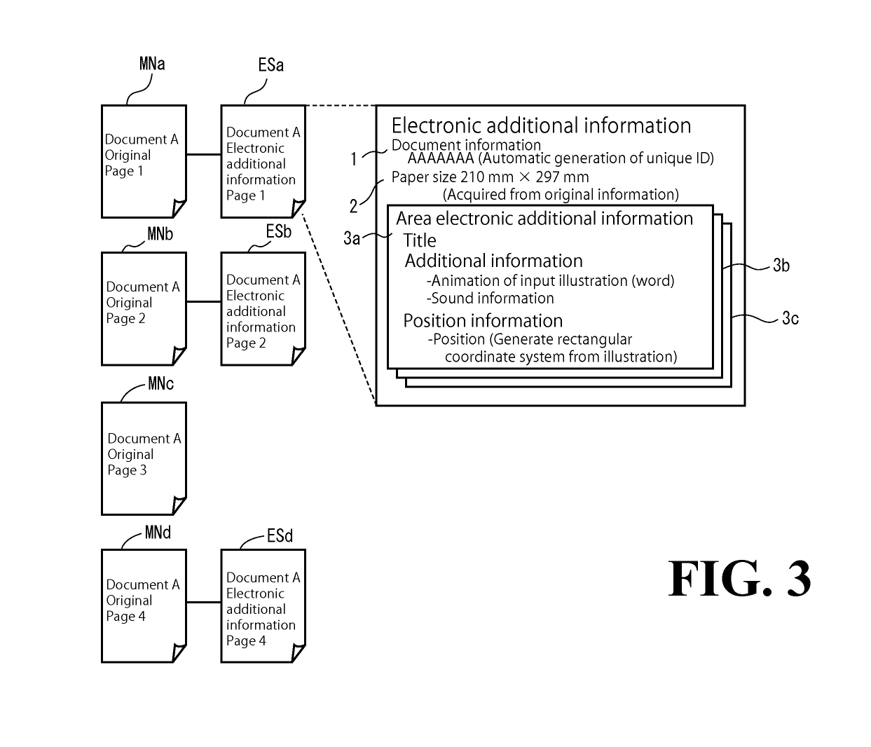

FIG. 3 illustrates a relationship between the subject MN and the electronic additional information. In this example, the subject MN is a four-page document A. The first page, MNa, of the document A is corresponding to electronic additional information ESa. The second page, MNb, is corresponding to electronic additional information ESb. The fourth page, MNd, is corresponding to electronic additional information ESd. In this example, no electronic additional information exists that corresponds to the third page, MNc, of the document A.

As shown in FIG. 3, examples of the electronic additional information ESa include ID information 1 (indicated as AAAAAAA), size information 2, and pieces of area electronic additional information 3a to 3c. The ID information 1 indicates the first page of the document A. The size information 2 indicates paper size. The pieces of area electronic additional information 3a to 3c each indicate at which position within the first page of the document A (for example, a position relative to the origin position of the page, described later) to place an air tag, what air tag of title (item) to display, and what kind of additional information exists (for example, an animation of an illustration and sound information on appliance operation statuses). The individual pieces of area electronic additional information 3a to 3c correspond to each individual air tag displayed on the display section 101.

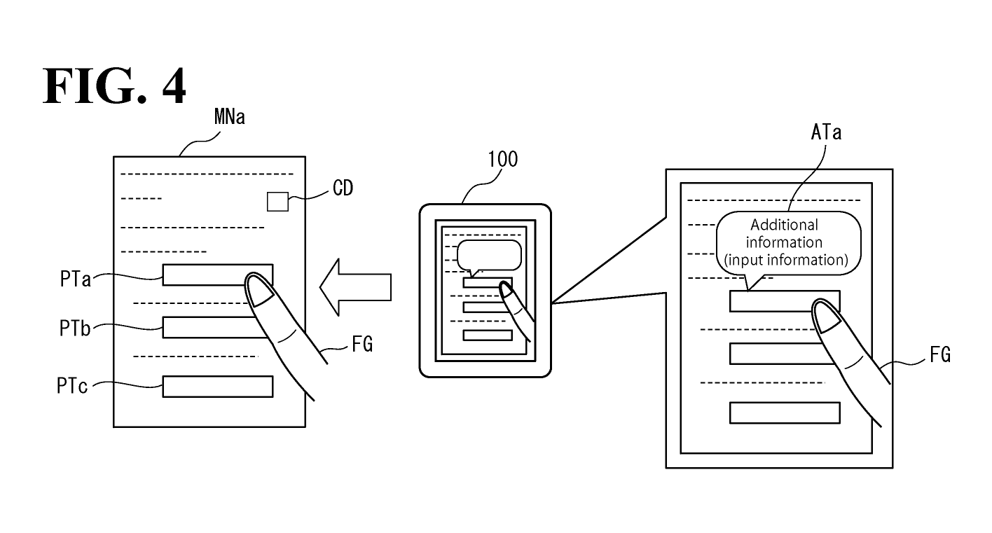

FIG. 4 illustrates exemplary air tags displayed on the image processing terminal 100. As shown in FIG. 4, the first page, MNa, of the document A is in advance assigned a particular code CD such as a two-dimensional code. The particular code CD corresponds to the ID information 1, which indicates the first page of the document A, and is provided by printing, seal attachment, or any other method. The particular code CD indicates the ID information 1, which in turn indicates the first page of the document A. The first page, MNa, of the document A includes air tag displayable positions PTa to PTc. The air tag displayable positions PTa to PTc are positions where air tags respectively corresponding to the pieces of area electronic additional information 3a to 3c are displayable. In FIG. 4, the display section 101 of the image processing terminal 100 displays an air tag ATa alone, which corresponds to the air tag displayable position PTa.

The air tag ATa is disposed on the display section 101 at a position specified by the position information in the area electronic additional information 3a. Here, the air tag ATa is an item indicating the content of the electronic additional information, and is displayed in text form in what is called a balloon often used in cartoons (in this example, the indication “Additional information”).

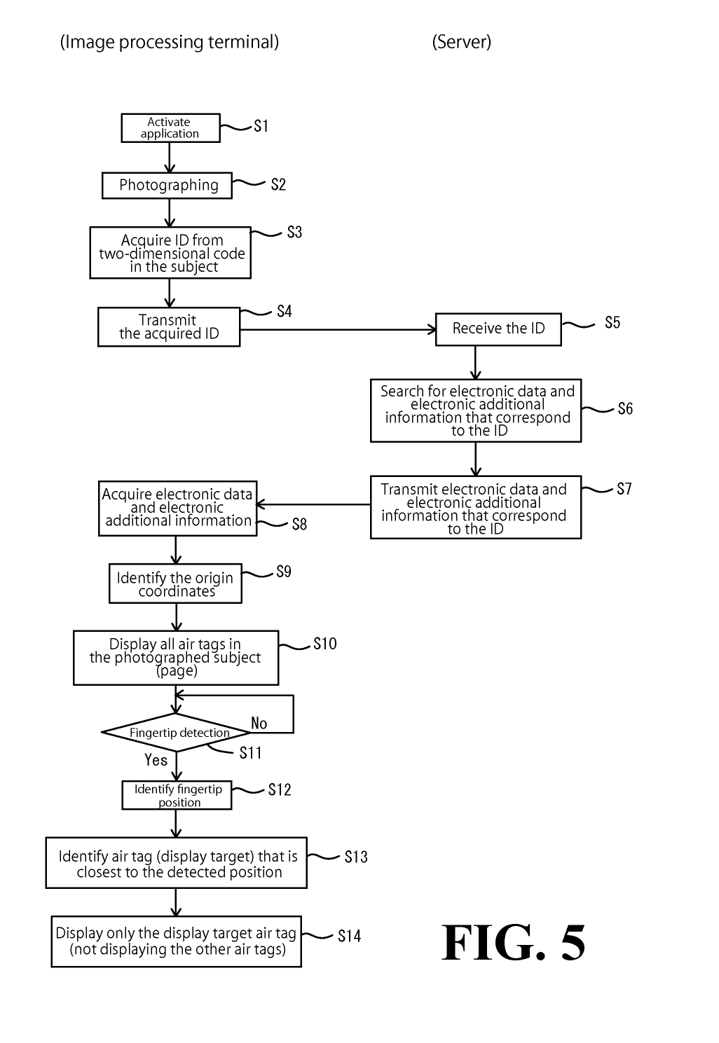

FIG. 5 is a flowchart of processing executed at the image processing terminal 100 and the server 300.

First, the user handles the image processing terminal 100 to activate an application program according to this embodiment (step S1). Next, the subject MN is photographed (step S2).

Here, the image processing section 103 includes an image analysis section 103a, a display control section 103b, an electronic additional information obtaining section 103c, and a finger detection data 103d.

The image analysis section 103a determines, by a known image analysis technique, whether the photographed subject MN contains a particular code CD, such as a two-dimensional code. When a particular code CD is contained, the image analysis section 103a specifies a content indicated by the particular code CD (in this example, the ID information 1, which indicates the first page of the document A) (step S3). Then, the electronic additional information obtaining section 103c receives, from the image analysis section 103a, the ID information 1 obtained using the particular code CD as a key, and transmits the ID information 1 to the server 300 from the network interface 104 through the network 200 (step S4). This causes the image processing terminal 100 to make a demand to the database 301 on the server 300 for electronic data of the first page, MNa, of the document A and for the electronic additional information ESa of the first page, MNa, of the document A stored in the database 301 and corresponding to the ID information 1, which indicates the first page of the document A and is indicated by the particular code CD.

The server 300 receives the ID information 1 transmitted from the image processing terminal 100 (step S5), and searches the database 301 for electronic data and electronic additional information that correspond to the ID information 1 (step S6). When electronic data and electronic additional information that correspond to the ID information 1 exist, the server 300 transmits the electronic data and electronic additional information to the image processing terminal 100 (step S7). Thus, the network interface 104 receives the electronic data and electronic additional information from the server 300, and the electronic additional information obtaining section 103c obtains the electronic data and electronic additional information of the first page, MNa, of the document A (step S8). When the search in the database 301 finds no relevant electronic data or electronic additional information, the server 300 may transmit to the image processing terminal 100 error information or similar information notifying search failure, and the image processing terminal 100 may display an error message.

The image analysis section 103a determines, by a known image analysis technique, the paper area and paper orientation of the first page, MNa, of the photographed document A. Then, based on the determination, the image analysis section 103a specifies the origin position (for example, the upper left corner of the paper) of the first page, MNa, of the document A (step S9). Next, based on the position information contained in each of the pieces of area electronic additional information contained in the electronic additional information, the display control section 103b checks a position relative to the origin position specified at step 9. Thus, the display control section 103b recognizes the display positions of all the air tags respectively corresponding to the pieces of area electronic additional information obtained from the electronic additional information on the subject MN displayed on the display section 101. The display control section 103b then displays all the air tags in such a manner that the air tags are superimposed over the image of the subject MN at their respective display positions (step 10).

Specifically, when the first page, MNa, of the document A shown in FIG. 4 is photographed, the display control section 103b specifies a position relative to the origin position specified at step 9 from the pieces of position information (see FIG. 3) contained in the pieces of area electronic additional information 3a to 3c of the electronic additional information. Thus, the display control section 103b specifies the air tag displayable positions PTa to PTc in the first page, MNa, of the document A displayed on the display section 101, and displays, at the air tag displayable positions PTa to PTc, the air tags indicating titles (item names) respectively corresponding to the pieces of area electronic additional information 3a to 3c.

Regarding how to display the air tags, it is possible to superimpose the air tags over the first page, MNa, of the document A displayed in real time on the display section 101. It is also possible to superimpose the air tags over the electronic data of the first page, MNa, of the document A obtained by the electronic additional information obtaining section 103c.

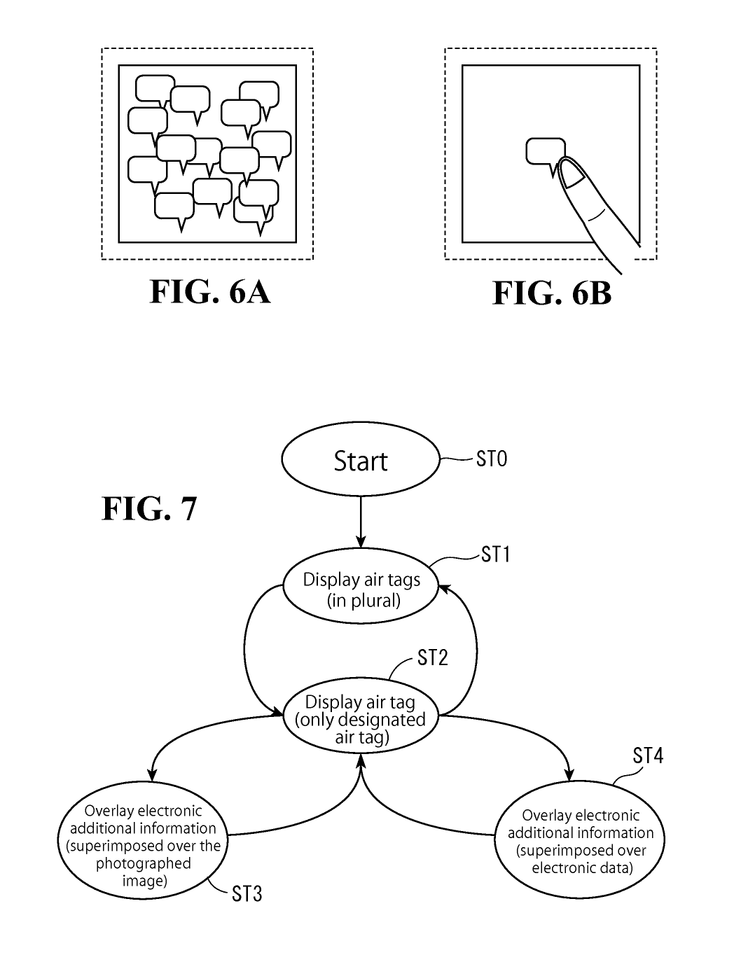

FIGS. 6A and 6B illustrate states in which air tags are superimposed over the subject MN displayed in real time on the display section 101. FIG. 6A illustrates a state in which a plurality of air tags are displayed on the display section 101 of the image processing terminal 100 as a result of the image processing terminal 100 and the server 300 performing the operations at steps 1 to 10.

Here, displaying a large number of air tags on the display section 101 as shown in FIG. 6A can cause an erroneous touch on an adjacent air tag on the touch screen display section. Thus, it can be difficult to select a desired air tag.

In view of this, in this embodiment, as shown in FIG. 4, the user of the image processing terminal 100 points to a position, among the air tag displayable positions PTa to PTc within the subject MNa, that is the desired position to display the electronic additional information. The user does this operation of pointing at a fingertip FG of the user on the subject MNa instead of on the display section 101. Then, based on this operation of pointing, the image analysis section 103a of the image processing section 103 uses the finger detection data 103d to specify by image analysis the position of the fingertip FG on the display section 101, thereby specifying which of the air tag displayable positions PTa to PTc within the subject MNa is pointed to. Then, the image analysis section 103a causes the display section 101 to display only the air tag ATa, among the plurality of air tags, which is corresponding to the air tag displayable position PTa, which is the particular position pointed to by the fingertip FG.

Specifically, referring to the flowchart in FIG. 5, at step 10, the image processing terminal 100 displays all the air tags ATa to ATc respectively of the air tag displayable positions PTa to PTc. Then, the image analysis section 103a detects whether the photographing section 102 has photographed the fingertip FG of the user (step S11). Here, when the user points, at the user's fingertip FG, to any of the air tag displayable positions PTa to PTc on the subject MNa (that is, on the printed material) within a field angle of the photographing section 102 photographing the subject MNa, then the photographing section 102 photographs the fingertip FG of the user pointing to the subject MNa. Thus, now that the image analysis section 103a detects the photographing section 102 photographing the fingertip FG of the user pointing to the subject MNa (Yes at step S11), the image analysis section 103a specifies the position of the fingertip FG of the user pointing to the subject MNa (step S12).

Here, the image analysis section 103a uses the finger detection data 103d to perform known image analysis, thereby specifying the position of the fingertip of the user pointing to the display section 101. The finger detection data 103d contains known data about fingertip image detection such as image analysis color data indicating the contrast between the fingertip color (usually flesh color) and the color (usually white) of the printed material, and image analysis shape data indicating the fingertip shape. Then, the image analysis section 103a converts the position of the fingertip FG into two-dimensional coordinates on the subject MN. In the operations at steps S11 and S12 to determine the position to which the fingertip FG points, it is possible to make the determination when, for example, the fingertip FG detected based on the finger detection data 103d stays within a predetermined distance range for over a predetermined period of time.

Next, the display control section 103b specifies, as the particular position pointed to for air tag display, one of the air tag displayable positions PTa to PTc within the subject MNa that is closest to the converted coordinates (step S13). Then, the display control section 103b displays on the display section 101 only the air tag, among the plurality of air tags, corresponding to the particular position specified at step S13 (step S14). This state corresponds to the right end representation of FIG. 4 and to FIG. 6B.

Then, the display control section 103b displays on the display section 101 the content of the electronic additional information (for example, moving image information on appliance operation statuses) corresponding to the air tag corresponding to the particular position.

FIG. 7 is a state transition diagram illustrating how the electronic additional information is displayed when a particular air tag is pointed to from among a plurality of air tags. When the above-described application program is activated and the air tags are displayed on the display section 101 at their respective positions respectively corresponding to the air tag displayable positions PTa to PTc, this state is referred to as a state ST1.

When in the state ST1 an air tag is specified by the fingertip, the state ST1 shifts to a state ST2, in which only the designated air tag is displayed. When in the state ST2 the user moves the fingertip FG off the subject MN and the fingertip FG is no longer displayed on the display section 101, or when the user acts as if the user was undecided, moving the fingertip FG restlessly, then it is possible to delete the specified air tag and return the state ST2 to the state ST1. Then, when the user points to another air tag at the fingertip FG, the state ST1 again shifts to the state ST2.

In the state ST2, when the user performs a double tap operation (which is an operation of quickly tapping the fingertip on the paper twice) while pointing to the particular position on the subject MN, then the image analysis section 103a recognizes this operation by known image analysis using the finger detection data 103d, and the state ST2 shifts to a state ST3, in which the content of the electronic additional information is displayed while being superimposed over the subject MN displayed in real time.

In the state ST3, the display control section 103b deletes the designated air tag that is on display, and superimposes the content of the electronic additional information (for example, help information explaining the word, a detailed configuration of the drawing, and moving image information on appliance operation statuses) corresponding to the air tag over the subject MN displayed in real time. Thus, the content of the electronic additional information is displayed in an overlaid manner. Then, when the display of the content of the electronic additional information ends, or when the user makes a force-quit command with respect to the display of the content of the electronic additional information (by performing, for example, a pinch-in operation (which is an operation of two fingertips on the paper shifting from a state in which the two fingertips are apart from one another to a state in which they are close to one another)), then the state ST3 returns to the state ST2.

In the state ST3, the content of the electronic additional information is displayed in an overlaid manner, that is, the content of the electronic additional information is superimposed over the subject MN displayed in real time. With the subject MN displayed in real time, however, viewing difficulties can occur due to hand jiggling or similar occurrences. In this case, in the state ST2, the user may perform a pinch-out operation using two fingers while pointing to the particular position on the subject MN. (The pinch-out operation is an operation of two fingertips on the paper shifting from a state in which the two fingertips are close to one another to a state in which they are apart from one another.) When the pinch-out operation is performed, the image analysis section 103a recognizes this operation by known image analysis using the finger detection data 103d, and the state ST2 shifts to a state ST4, in which the content of the electronic additional information is displayed while being superimposed over the electronic data of the subject MN.

In the state ST4, the display control section 103b deletes the designated air tag that is on display and ends the real-time display of the real image. Then, the display control section 103b superimposes the content of the electronic additional information (for example, help information explaining the word, a detailed configuration of the drawing, and moving image information on appliance operation statuses) corresponding to the air tag over the electronic data of the subject MN (for example, PDF data or JPEG data obtained by scanning the subject MN in advance) called up from the database 301 in advance. Thus, the content of the electronic additional information is displayed in an overlaid manner. Thus, use of the electronic data of the subject MN to display the content of the electronic additional information in an overlaid manner ensures clear display of the subject MN on the display section 101 regardless of hand jiggling or similar occurrences. Then, when the display of the content of the electronic additional information ends, or when the user makes a force-quit command with respect to the display of the content of the electronic additional information (by performing, for example, the pinch-in operation), then the state ST4 returns to the state ST2.

In the above example, prior to the operation of pointing by the user of the image processing terminal 100 at the fingertip FG, the display control section 103b of the image processing section 103 displays on the display section 101 all the plurality of air tags to be displayed. (This example corresponds to FIG. 4, which shows the state in which all the air tags are displayed on the display section 101 at their respective positions respectively corresponding to the air tag displayable positions PTa to PTc. The above example has a more direct connection to the state shown in FIG. 6A).

In this case, with all the air tags displayed, the user is able to, in advance, grasp the whole picture of the plurality of pieces of electronic additional information corresponding to the subject MN.

In this state, when the user of the image processing terminal 100 performs the operation of pointing at the fingertip FG, the display control section 103b may highlight only the specified air tag such as by changing the text size or the color of the specified air tag.

Then, the display control section 103b displays only the specified air tag, while deleting the display of the other air tags than the specified air tag. (This state corresponds to the right end representation of FIG. 4 and to FIG. 6B.) With this processing, in which all the plurality of air tags are displayed and then only the specified air tag is displayed, the user will not be annoyed by the display of unnecessary pieces of electronic additional information when the user needs access to a necessary piece of electronic additional information.

It should be noted, however, that the present invention does not exclude the option of the display control section 103b of the image processing section 103 not displaying the plurality of air tags to be displayed on the display section 101 prior to the operation of pointing by the user of the image processing terminal 100 at the fingertip FG.

It is of course possible to display all the plurality of air tags on the display section 101 at the time when the image analysis section 103a specifies the particular code CD and the electronic additional information obtaining section 103c obtains, using the particular code CD as a key, the electronic additional information and the electronic data information of the subject MN from the database 301. In this case, however, a large number of air tags would be displayed as in FIG. 6A, which might confuse the user.

In view of this, in this case, instead of displaying the plurality of air tags to be displayed on the display section 101, it is possible to display only the air tag corresponding to the position specified by the user's operation of pointing on the subject MN at the fingertip FG. This ensures a simple display screen with minimized air tag display.

With the image processing system and the method for processing an image according to this embodiment, based on the operation of pointing, on the subject MN instead of on the display section 101, to a particular position within the subject MN by the user of the image processing terminal 100 at the fingertip FG, the image processing section 103 specifies the position of the fingertip FG on the display section 101 by image analysis, thereby specifying the particular position within the subject MN. Then, the image processing section 103 displays on the display section 101 only the air tag, among the plurality of air tags, corresponding to the particular position. This eliminates or minimizes difficulty in selecting an air tag, and realizes an image processing system and a method for processing an image that ensure selection of a desired air tag even when a large number of air tags exist.

Also in the image processing system and the method for processing an image according to this embodiment, it is possible, after the operation of pointing at the fingertip FG, to delete the display of the other air tags than the air tag corresponding to the particular position, and display only the air tag corresponding to the particular position. In this case, the user is able to, in advance, grasp the whole picture of the plurality of pieces of electronic additional information corresponding to the subject MN, while at the same time the user will not be annoyed by the display of unnecessary pieces of electronic additional information when the user needs access to a necessary piece of electronic additional information.

### Embodiment 2

This embodiment is a modification of the image processing system and the method for processing an image according to embodiment 1, and is regarding such an image processing system and a method for processing an image that based on an operation of zooming in on a particular position within the subject MN displayed on the display section 101 or based on an operation of making the photographing section 102 close to the particular position within the subject MN performed by the user of the image processing terminal 100, instead of based on the user's pointing to the particular position within the subject at a fingertip of the user, the image processing section 103 specifies the particular position within the subject MN. Then, the image processing section 103 displays on the display section 101 only the air tag, among the plurality of air tags, corresponding to the particular position.

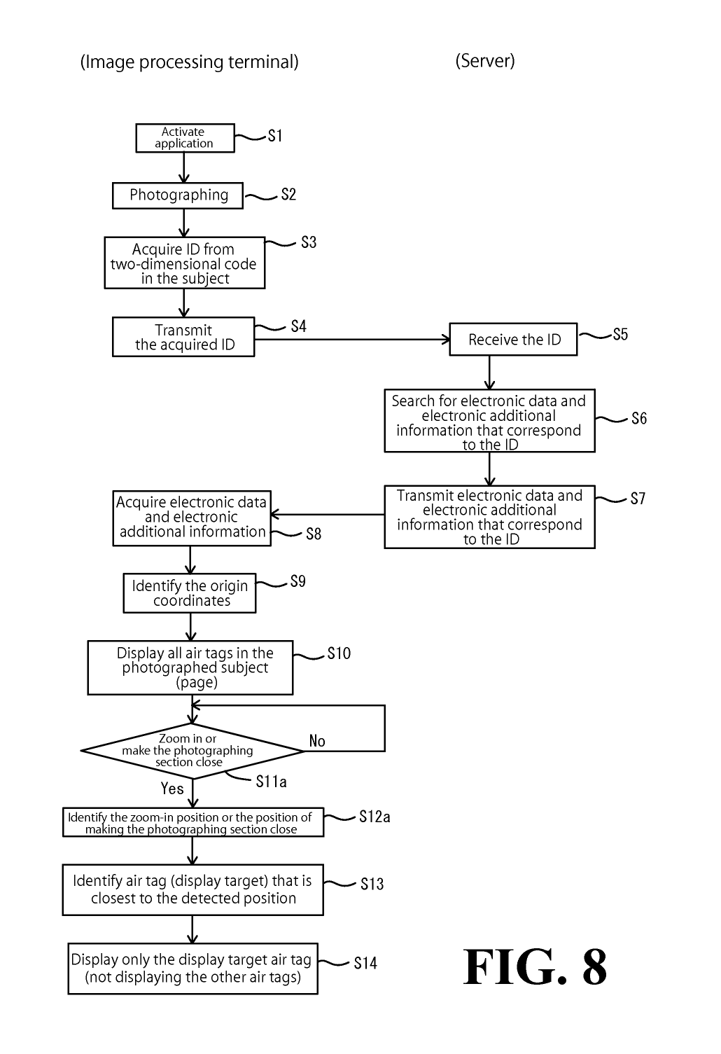

FIG. 8 is a flowchart of processing executed the image processing terminal 100 and the server 300 in the image processing system and the method for processing an image according to this embodiment. Steps S1 to S10 will not be elaborated here, since they are identical to those in the flow shown in FIG. 5, which concerns the image processing system and the method for processing an image according to embodiment 1.

Here, displaying a large number of air tags on the display section 101 as shown in FIG. 6A can cause an erroneous touch on an adjacent air tag on the touch screen display section. Thus, it can be difficult to select a desired air tag.

In view of this, in this embodiment, the desired position to display the electronic additional information is designated among the air tag displayable positions PTa to PTc within the subject MN in the following manner. Specifically, the user of the image processing terminal 100 performs an operation of zooming in on a particular position within the subject MN displayed on the display section 101 so that only one air tag displayable position is contained in the display area of the display section 101, or the user performs an operation of making the photographing section 102 close to the particular position within the subject MN so that only one air tag displayable position is contained in the field angle of the photographing section 102. Here, the image processing terminal 100 has its image analysis section 103a detect whether the user has performed the zoom-in operation or the closeup operation (step S11a). Then, when the image analysis section 103a detects the user's zoom-in operation or closeup operation (Yes at step 11a), then the image analysis section 103a specifies where the particular position targeted for the zoom-in or closeup is within the subject MN (step S12a), and displays on the display section 101 an only air tag, among a plurality of air tags, corresponding to the particular position (step S13).

When the above-described operation is performed to display only the air tag corresponding to the particular position, the image analysis section 103a has already determined, at step S9, the paper area and paper orientation of the photographed subject MN by a known image analysis technique. Based on the determination, the image analysis section 103a has already specified the origin (for example, the upper left corner of the paper) of the subject MN. Thus, when the user handles the image processing terminal 100 to perform the operation of zooming in on the particular position within the subject MN displayed on the display section 101, or to perform the operation of making the photographing section 102 close to the particular position within the subject MN, the coordinates of the position displayed on the display section 101 after the zoom-in operation or the operation of making the photographing section 102 close to the particular position are calculated by a known image processing technique.

Based on this calculation, the image analysis section 103a converts the position into two-dimensional coordinates on the subject MN. Next, the display control section 103b specifies, as the particular position, one of the air tag displayable positions PTa to PTc within the subject MNa that is closest to the converted coordinates. Then, the display control section 103b displays on the display section 101 only the air tag, among the plurality of air tags, corresponding to the particular position. This state corresponds to the right end representation of FIG. 4 and to FIG. 6B.

It is noted that since no fingertip detection is performed in this embodiment, the finger detection data 103d is not necessary in the configuration of the image processing terminal 100 shown in FIG. 2.

At the time of specifying the air tag, it is possible to change the display form of the air tag in conjunction with the operation of zooming in on the particular position within the subject MN displayed on the display section 101 or the operation of making the photographing section 102 close to the particular position within the subject MN. For example, it is possible to gradually diminish the text size of the displayed item in the air tag in conjunction with an operation of increasing the text size of the displayed item in the air tag and/or an operation of zooming out from the particular position within the subject MN displayed on the display section 101, or in conjunction with an operation of making the photographing section 102 apart from the particular position within the subject MN.

When the electronic additional information is displayed as text information after the air tag has been specified, it is possible to change how to display the electronic additional information in conjunction with the operation of further zooming in on the particular position within the subject MN displayed on the display section 101 or the operation of making the photographing section 102 closer to the particular position within the subject MN. For example, it is possible to gradually diminish the text size of the electronic additional information or reduce the number of text words to be displayed in conjunction with the operation of increasing the text size of the electronic additional information and increasing the number of text words to be displayed and/or the operation of zooming out from the particular position within the subject MN displayed on the display section 101, or in conjunction with the operation of making the photographing section 102 apart from the particular position within the subject MN.

Embodiment 2 is otherwise similar to the image processing system and the method for processing an image according to embodiment 1, and will not be further elaborated here.

With the image processing system and the method for processing an image according to this embodiment, based on the operation of zooming in on the particular position within the subject MN displayed on the display section 101 or the operation of making the photographing section 102 close to the particular position within the subject MN performed by the user of the image processing terminal 100, the image processing section 103 specifies the particular position within the subject MN and displays on the display section 101 only the air tag, among the plurality of air tags, corresponding to the particular position. This eliminates or minimizes difficulty in selecting an air tag, and realizes an image processing system and a method for processing an image that ensure selection of a desired air tag even when a large number of air tags exist.

While the above-described embodiments are regarding an image processing system and a method for processing an image, these embodiments should not be construed as limiting the present invention. The present invention encompasses a program (application program) that causes various image processing terminals implemented by various computers to perform the steps of the method for processing an image according to the above-described embodiments. This realizes a program that ensures such a method for processing an image that ensures selection of a desired air tag even when a large number of air tags exist.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. An image processing terminal comprising:
a photographing section configured to photograph an image of a subject;
a display section configured to display the image of the subject photographed by the photographing section;
an electronic additional information obtaining section configured to obtain electronic additional information to be added to the image of the subject photographed by the photographing section;
a display control section configured to control the display section to display the image of the subject with at least one air tag superimposed over the image of the subject, the at least one air tag corresponding to the electronic additional information obtained by the electronic additional information obtaining section; and
an image analysis section configured to analyze the image of the subject photographed by the photographing section,
wherein the at least one air tag comprises a plurality of air tags, and
wherein in the case where, while the display section is displaying the plurality of air tags,
the photographing section photographs an operation of pointing to a particular position within the subject by a fingertip of a user of the image processing terminal,
the image analysis section is configured to specify a position of the fingertip in the subject photographed by the photographing section so as to specify the particular position within the subject pointed to by the fingertip; and
the display section is configured to display an air tag, among the plurality of air tags, corresponding to the particular position specified by the image analysis section.

2. An image processing terminal comprising:
a photographing section configured to photograph an image of a subject;
a display section configured to display the image of the subject photographed by the photographing section;
an electronic additional information obtaining section configured to obtain electronic additional information to be added to the subject photographed by the photographing section;
a display control section configured to control the display section to display the image of the subject with at least one air tag superimposed over the image of the subject, the at least one air tag corresponding to the electronic additional information obtained by the electronic additional information obtaining section; and
an image analysis section configured to analyze the image of the subject photographed by the photographing section,
wherein the at least one air tag comprises a plurality of air tags, and
wherein in the case where, while the display section is displaying the plurality of air tags,
the photographing section executes zoom-in or closeup with respect to a particular position within the subject,
the image analysis section is configured to specify the particular position within the subject that has been subjected to the zoom-in or the closeup by the photographing section; and
the display section is configured to display an air tag, among the plurality of air tags, corresponding to the particular position specified by the image analysis section.

3. The image processing terminal according to claim 1,
wherein the subject is assigned a particular code, and
wherein the image analysis section is configured to analyze the image of the subject photographed by the photographing section so as to extract the particular code of the subject.

4. The image processing terminal according to claim 1, wherein the image of the subject over which the display control section superimposes the at least one air tag comprises a real-time image of the subject photographed by the photographing section.

5. The image processing terminal according to claim 1, wherein the image of the subject over which the display control section superimposes the at least one air tag comprises an image obtained from electronic data of the subject.

6. The image processing terminal according to claim 1, further comprising a network interface configured to communicate with a server through a network, the server comprising a database that stores the electronic additional information of the subject in relation to a particular code to specify the subject,
wherein the network interface is configured to transmit to the server the particular code to specify the subject photographed by the photographing section, and configured to receive from the server the electronic additional information of the subject so that the electronic additional information obtaining section obtains the electronic additional information.

7. The image processing terminal according to claim 1, wherein the image analysis section is configured to specify an origin position of the subject, and then specify a coordinate position of the particular position corresponding to the at least one air tag using coordinates relative to the origin position.

8. The image processing terminal according to claim 1, wherein when the image analysis section recognizes a double tap operation on the subject performed by the user, the display control section is configured to control the display section to display the image of the subject with the at least one air tag superimposed over the image of the subject.

9. The image processing terminal according to claim 1, wherein when the image analysis section recognizes a pinch-out operation on the subject performed by the user, the display control section is configured to control the display section to display the image of the subject with the at least one air tag superimposed over the image of the subject.

10. The image processing terminal according to claim 1, wherein the display section is configured to highlight the air tag that is corresponding to the particular position specified by the image analysis section.

11. An image processing system comprising:
the image processing terminal according to claim 1; and
a server connectable to the image processing terminal through a network,
wherein the server comprises a database that stores electronic additional information of a subject in relation to a particular code to specify the subject, and
wherein the image processing terminal is configured to transmit to the server the particular code to specify the subject photographed by a photographing section of the image processing terminal, and configured to receive from the server the electronic additional information of the subject so that an electronic additional information obtaining section of the image processing terminal obtains the electronic additional information.

12. A computer-readable storage medium storing a control program of an image processing terminal, the image processing terminal comprising: a photographing section configured to photograph an image of a subject; and a display section configured to display the image of the subject photographed by the photographing section, the control program causing a computer to perform:
obtaining electronic additional information to be added to the subject photographed by the photographing section;
controlling the display section to display the image of the subject with at least one air tag superimposed over the image of the subject, the at least one air tag corresponding to the electronic additional information obtained in the obtaining step;
in the case where, while the display section is displaying a plurality of air tags in the controlling step, the photographing section photographs an operation of pointing to a particular position within the subject by a fingertip of a user of the image processing terminal, specifying a position of the fingertip in the subject photographed by the photographing section so as to specify the particular position within the subject pointed to by the fingertip; and
controlling the display section to display an air tag, among the plurality of air tags, corresponding to the particular position specified in the image analysis performing step.

13. A computer-readable storage medium storing a control program of an image processing terminal, the image processing terminal comprising: a photographing section configured to photograph an image of a subject; and a display section configured to display the image of the subject photographed by the photographing section, the control program causing a computer to perform:
obtaining electronic additional information to be added to the subject photographed by the photographing section;
controlling the display section to display the image of the subject with at least one air tag superimposed over the image of the subject, the at least one air tag corresponding to the electronic additional information obtained in the obtaining step;
in the case where, while the display section is displaying a plurality of air tags in the controlling step, the photographing section executes zoom-in or closeup with respect to a particular position within the subject, specifying the particular position within the subject that has been subjected to the zoom-in or the closeup by the photographing section; and
controlling the display section to display an air tag, among the plurality of air tags, corresponding to the particular position specified in the specifying step.

14. The image processing terminal according to claim 2,
wherein the subject is assigned a particular code, and
wherein the image analysis section is configured to analyze the image of the subject photographed by the photographing section so as to extract the particular code of the subject.

15. The image processing terminal according to claim 2, wherein the image of the subject over which the display control section superimposes the at least one air tag comprises a real-time image of the subject photographed by the photographing section.

16. The image processing terminal according to claim 3, wherein the image of the subject over which the display control section superimposes the at least one air tag comprises a real-time image of the subject photographed by the photographing section.

17. The image processing terminal according to claim 14, wherein the image of the subject over which the display control section superimposes the at least one air tag comprises a real-time image of the subject photographed by the photographing section.

18. The image processing terminal according to claim 2, wherein the image of the subject over which the display control section superimposes the at least one air tag comprises an image obtained from electronic data of the subject.

19. The image processing terminal according to claim 3, wherein the image of the subject over which the display control section superimposes the at least one air tag comprises an image obtained from electronic data of the subject.

20. The image processing terminal according to claim 14, wherein the image of the subject over which the display control section superimposes the at least one air tag comprises an image obtained from electronic data of the subject.
